(19) United States
(12) Patent Application Publication
(10) Pub. No.: US 2025/0220430 A1
(43) Pub. Date: Jul. 3, 2025

(54) VERIFYING LEGITIMACY OF REFERENCE SIGNALS

(71) Applicant: QUALCOMM Incorporated, San Diego, CA (US)

(72) Inventors: Ahmed ELSHAFIE, San Diego, CA (US); Hung Dinh LY, San Diego, CA (US); Alexandros MANOLAKOS, Athens (GR); Yu ZHANG, San Diego, CA (US)

(21) Appl. No.: 18/841,720

(22) PCT Filed: Mar. 22, 2023
(86) PCT No.: PCT/US2023/015921

§ 371 Date: Aug. 27, 2024

(30) Foreign Application Priority Data
Apr. 7, 2022 (GR) 20220100306

(51) Int. Cl. H04W 12/106; H04L 5/00; H04W 12/041

(52) U.S. Cl. CPC H04W 12/106; H04L 5/0048; H04W 12/041

(57) ABSTRACT

Various aspects of the present disclosure generally relate to wireless communication. In some aspects, a wireless communication device may generate a signature associated with one or more reference signals to be transmitted by the wireless communication device, wherein the signature is associated with verifying that the one or more reference signals are legitimate reference signals. The wireless communication device may transmit the one or more reference signals. The wireless communication device may transmit the signature associated with the one or more reference signals. Numerous other aspects are described.

### CROSS-REFERENCE TO RELATED APPLICATION

This patent application claims priority to Greece Patent Application No. 20220100306, filed on Apr. 7, 2022, entitled “VERIFYING LEGITIMACY OF REFERENCE SIGNALS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for verifying legitimacy of reference signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless communication device. The method may include generating a signature associated with one or more reference signals to be transmitted by the wireless communication device, where the signature is associated with verifying that the one or more reference signals are legitimate reference signals. The method may include transmitting the one or more reference signals. The method may include transmitting the signature associated with the one or more reference signals.

Some aspects described herein relate to a method of wireless communication performed by a wireless communication device. The method may include receiving one or more reference signals. The method may include receiving a signature associated with the one or more reference signals. The method may include performing a verification of the signature to determine whether the one or more reference signals are legitimate reference signals.

Some aspects described herein relate to a wireless communication device for wireless communication. The wireless communication device may include a memory and one or more processors coupled to the memory. The one or more processors may be configured to generate a signature associated with one or more reference signals to be transmitted by the wireless communication device. The one or more processors may be configured to transmit the one or more reference signals. The one or more processors may be configured to transmit the signature associated with the one or more reference signals.

Some aspects described herein relate to a wireless communication device for wireless communication. The wireless communication device may include a memory and one or more processors coupled to the memory. The one or more processors may be configured to receive one or more reference signals. The one or more processors may be configured to receive a signature associated with the one or more reference signals. The one or more processors may be configured to perform a verification of the signature to determine whether the one or more reference signals are legitimate reference signals.

Some aspects described herein relate to a non-transitory computer-readable medium that stores a set of instructions for wireless communication by a wireless communication device. The set of instructions, when executed by one or more processors of the wireless communication device, may cause the wireless communication device to generate a signature associated with one or more reference signals to be transmitted by the wireless communication device. The set of instructions, when executed by one or more processors of the wireless communication device, may cause the wireless communication device to transmit the one or more reference signals. The set of instructions, when executed by one or more processors of the wireless communication device, may cause the wireless communication device to transmit the signature associated with the one or more reference signals.

Some aspects described herein relate to a non-transitory computer-readable medium that stores a set of instructions for wireless communication by a wireless communication device.

The set of instructions, when executed by one or more processors of the wireless communication device, may cause the wireless communication device to receive one or more reference signals. The set of instructions, when executed by one or more processors of the wireless communication device, may cause the wireless communication device to receive a signature associated with the one or more reference signals. The set of instructions, when executed by one or more processors of the wireless communication device, may cause the wireless communication device to perform a verification of the signature to determine whether the one or more reference signals are legitimate reference signals.

Some aspects described herein relate to an apparatus for wireless communication. The apparatus may include means for generating a signature associated with one or more reference signals to be transmitted by the apparatus, where the signature is associated with verifying that the one or more reference signals are legitimate reference signals. The apparatus may include means for transmitting the one or more reference signals. The apparatus may include means for transmitting the signature associated with the one or more reference signals.

Some aspects described herein relate to an apparatus for wireless communication. The apparatus may include means for receiving one or more reference signals. The apparatus may include means for receiving a signature associated with the one or more reference signals. The apparatus may include means for performing a verification of the signature to determine whether the one or more reference signals are legitimate reference signals.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment in a wireless network, in accordance with the present disclosure.

FIGS. 3A-3D are diagrams illustrating examples associated with verifying legitimacy of reference signals, in accordance with the present disclosure.

FIGS. 4 and 5 are diagrams illustrating example processes associated with verifying legitimacy of reference signals, in accordance with the present disclosure.

FIGS. 6 and 7 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

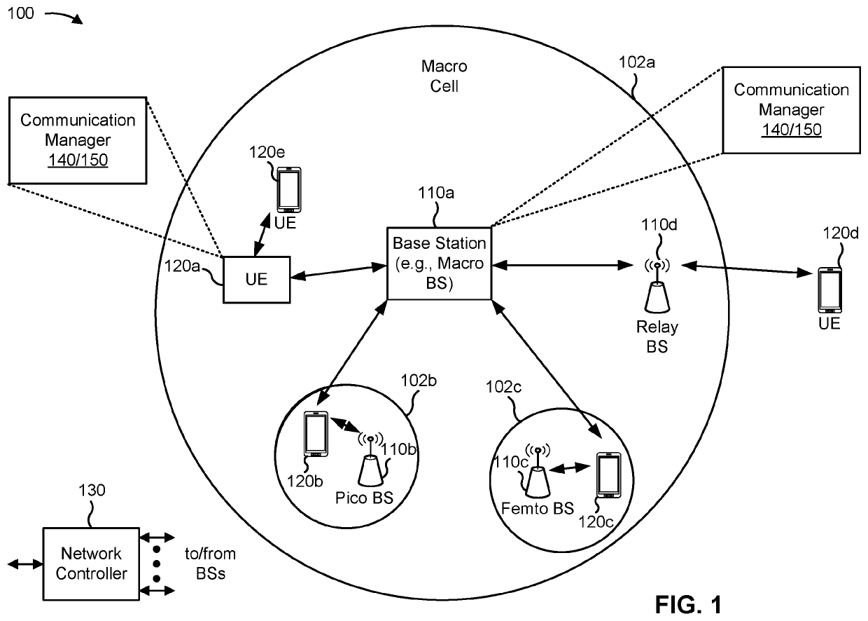

FIG. 1 is a diagram illustrating an example of a wireless network 100, in accordance with the present disclosure. The wireless network 100 may be or may include elements of a 5G (e.g., NR) network and/or a 4G (e.g., Long Tenn Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a wireless communication device (e.g., a UE 120, a base station 110, or the like) may include a communication manager 140. As described in more detail elsewhere herein, the communication manager 140 may generate a signature associated with one or more reference signals to be transmitted by the wireless communication device, wherein the signature is associated with verifying that the one or more reference signals are legitimate reference signals; transmit the one or more reference signals; and transmit the signature associated with the one or more reference signals. Additionally, or alternatively, the communication manager 140 may perform one or more other operations described herein.

In some aspects, a wireless communication device (e.g., a UE 120, a base station 110, or the like) may include a communication manager 150. As described in more detail elsewhere herein, the communication manager 150 may receive one or more reference signals; receive a signature associated with the one or more reference signals; and perform a verification of the signature to determine whether the one or more reference signals are legitimate reference signals. Additionally, or alternatively, the communication manager 150 may perform one or more other operations described herein.

As indicated above, FIG. 1 is provided as an example. Other examples may differ from what is described with regard to FIG. 1.

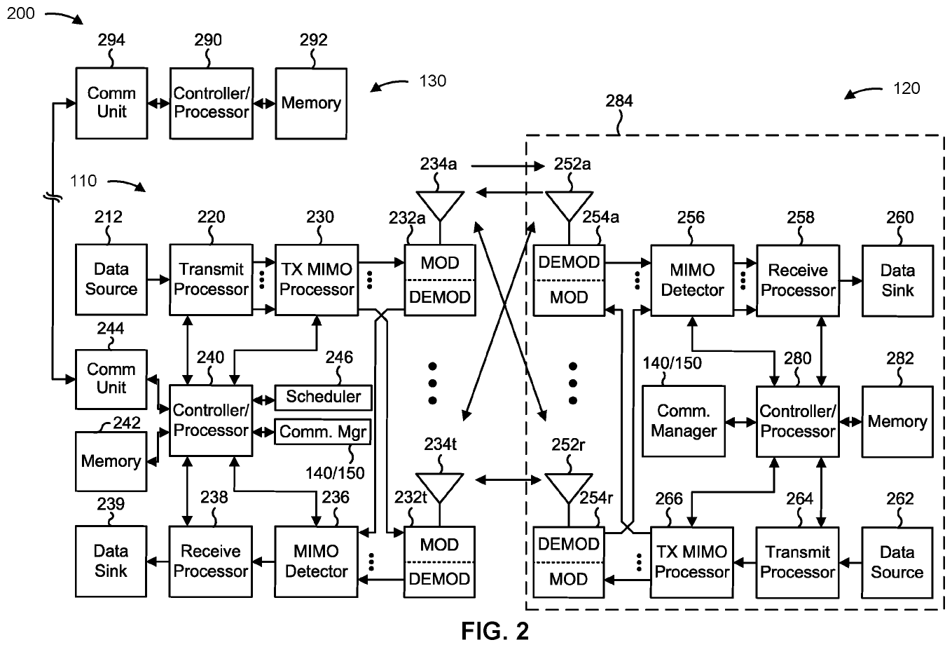

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

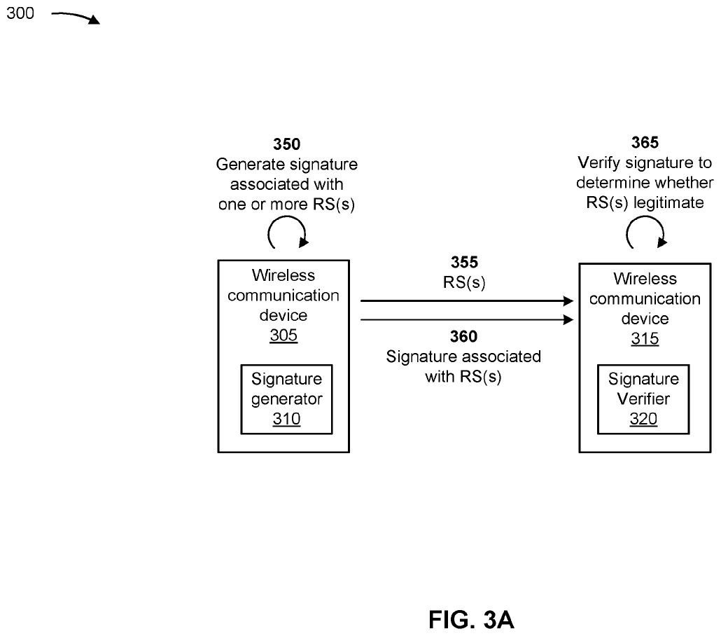

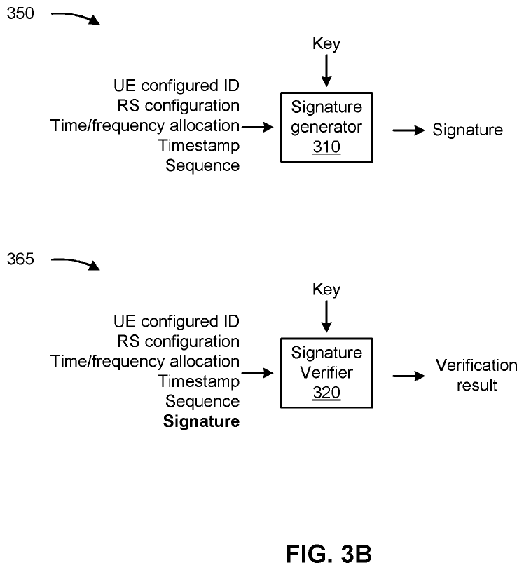

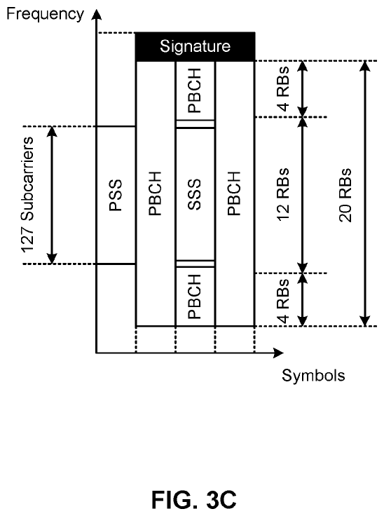

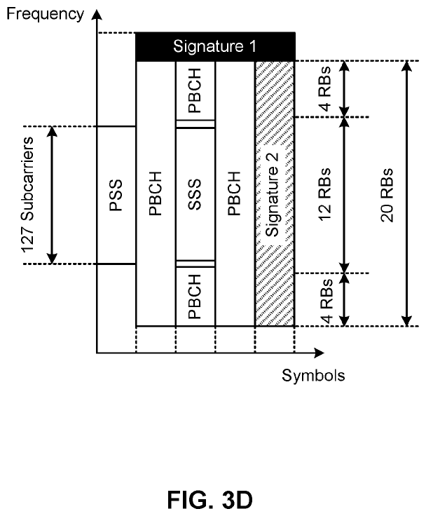

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3A-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3A-7).

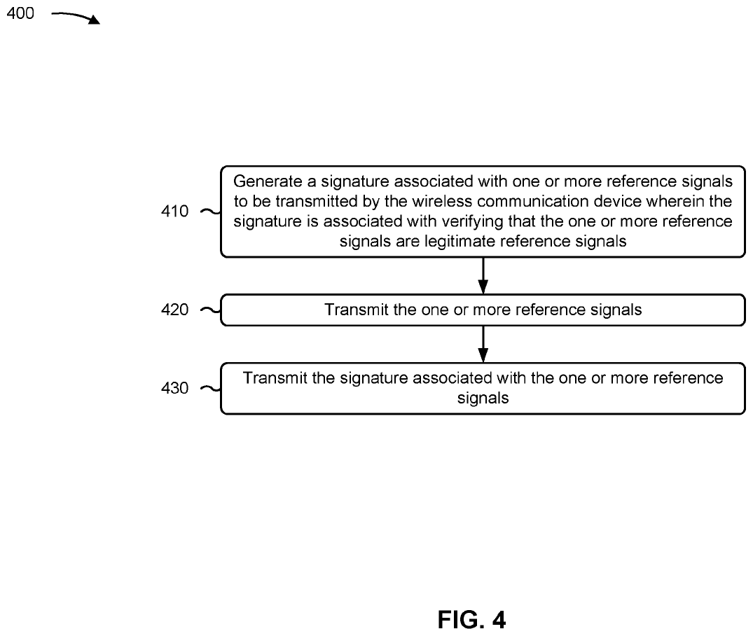

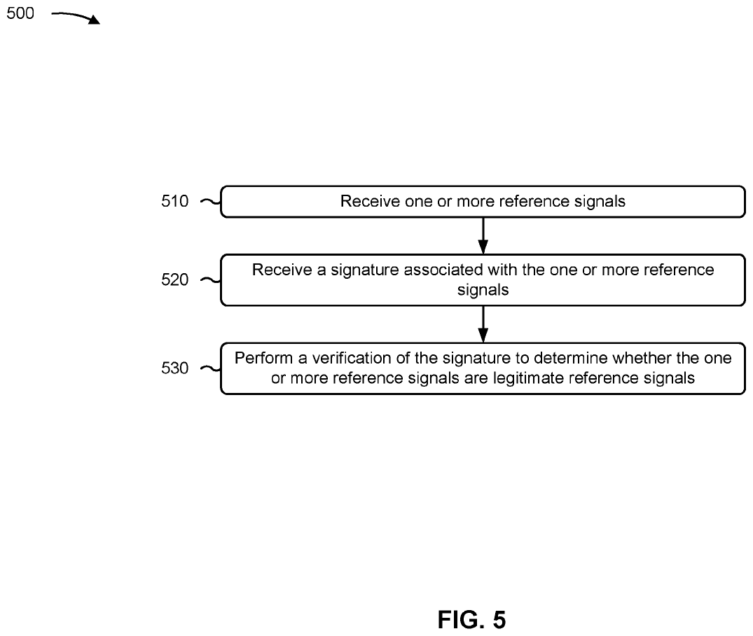

The controller/processor 240 of the base station 110, the controller/processor 280 of the UE 120, and/or any other component(s) of FIG. 2 may perform one or more techniques associated with verifying legitimacy of reference signals, as described in more detail elsewhere herein. For example, the controller/processor 240 of the base station 110, the controller/processor 280 of the UE 120, and/or any other component(s) of FIG. 2 may perform or direct operations of, for example, process 400 of FIG. 4, process 500 of FIG. 5, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 400 of FIG. 4, process 500 of FIG. 5, and/or other processes as described herein. In some examples, executing instructions may include running the instructions, converting the instructions, compiling the instructions, and/or interpreting the instructions, among other examples.

In some aspects, a wireless communication device includes means for generating a signature associated with one or more reference signals to be transmitted by the wireless communication device, wherein the signature is associated with verifying that the one or more reference signals are legitimate reference signals; means for transmitting the one or more reference signals; and/or means for transmitting the signature associated with the one or more reference signals. In some aspects, a wireless communication device includes means for receiving one or more reference signals; means for receiving a signature associated with the one or more reference signals; and/or means for performing a verification of the signature to determine whether the one or more reference signals are legitimate reference signals. In some aspects, the means for the wireless communication device to perform operations described herein may include, for example, one or more of communication manager 140; communication manager 150; transmit processor 220, TX MIMO processor 230, modem 232, antenna 234, MIMO detector 236, receive processor 238, controller/processor 240, memory 242, scheduler 246 (e.g., when the wireless communication device is a base station 110); or antenna 252, modem 254, MIMO detector 256, receive processor 258, transmit processor 264, TX MIMO processor 266, controller/processor 280, or memory 282 (e.g., when the wireless communication device is a UE 120).

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Providing security and authenticity for wireless communication is important for a wireless communication system. Security and authenticity are particularly important in a wireless communication system with many connected devices, such as a wireless communication system with a large quantity of connected IoT devices. Given the relatively low level of power of wireless communication devices such as IoT devices, increasing security by adding secure bits obtained from channels and signals communicated between wireless communication devices nodes is advantageous. Therefore, a wireless communication system that supports physical (PHY) layer security may be desirable.

In one example illustrating the importance of security and authenticity at the PHY layer, an attacker may attempt to intercept or otherwise impede wireless communications between legitimate wireless communication devices. For example, the attacker could transmit a falsified reference signal toward a legitimate UE in an attempt to cause the legitimate UE to identify the attacker as a legitimate UE or base station. The legitimate UE may receive the falsified reference signal and may use the falsified reference signal in association with performing wireless communications. As an example, if the attacker transmits a falsified synchronization signal block (SSB) toward a legitimate UE, then the legitimate UE may use the falsified SSB in association with performing synchronization, beam management, quasi co-location (QCL) relationships, or analog filtering of signals, among other examples. As a result, communication between the legitimate UE and other legitimate wireless communication devices may be disrupted or otherwise negatively impacted. Therefore, it is advantageous to enable a legitimate wireless communication device to determine whether a given reference signal received by the wireless communication device is a legitimate reference signal.

Some techniques and apparatuses described herein enable verifying legitimacy of reference signals. In some aspects, a wireless communication device (e.g., a base station 110, a UE 120, or the like) may generate a signature associated with one or more reference signals to be transmitted by the wireless communication device. Here, the signature is associated with verifying that the one or more reference signals are legitimate reference signals. The wireless communication device may then transmit the one or more reference signals and the signature associated with the one or more reference signals. In some aspects, another wireless communication device (e.g., a base station 110, a UE 120, or the like) may receive the one or more reference signals and the signature associated with the one or more reference signals. The other wireless communication device may then perform a verification of the signature to determine whether the one or more reference signals are legitimate reference signals. In this way, a wireless communication device can determine whether a given reference signal received by the wireless communication device is a legitimate reference signal, thereby increasing security and authenticity within a wireless communication system, as well as improving reliability of wireless communication and overall network performance. Additional details are provided below.

FIGS. 3A-3D are diagrams illustrating examples associated with verifying legitimacy of reference signals, in accordance with the present disclosure. FIG. 3A is a diagram illustrating an example 300 associated with verifying legitimacy of reference signals, in accordance with the present disclosure. As shown in FIG. 3A, example 300 includes communication between a wireless communication device 305 comprising a signature generator 310 and a wireless communication device 315 comprising a signature verifier 320. In some aspects, the wireless communication device 305 may be a base station 110 or, alternatively, may be a UE 120. In some aspects, the wireless communication device 315 may be a UE 120 or, alternatively, may be a base station 110. In some aspects, the wireless communication device 305 and the wireless communication device 315 may be included in a wireless network, such as wireless network 100. In some aspects, the wireless communication device 305 and the wireless communication device 315 may communicate via a wireless access link, which may include an uplink, a downlink, or a sidelink.

As shown by reference 350, the wireless communication device 305 (e.g., using signature generator 310) may generate a signature associated with one or more reference signals to be transmitted by the wireless communication device 305. In some aspects, the signature is associated with verifying that the one or more reference signals are legitimate reference signals. That is, the signature may, in some aspects, be an item of information that can be used by a wireless communication device to verify whether a reference signal received by the wireless communication device is a legitimate reference signal (i.e., that the reference signal was transmitted by a legitimate wireless communication device). Taking a synchronization signal block (SSB) as an example, the wireless communication device 305 may generate a signature based at least in part on a key and the SSB signal or SSB configuration. The wireless communication device 305 may also secure the content of the SSB using the key. The wireless communication device 305 may then transmit the SSB and the signature. If an attacker attempts to modify the SSB, then the attacker would also need to modify the signature. However, the attacker would be unable to generate a valid signature because the attacker would not have access to the key. In some aspects, the signature may be a cyclic redundancy check (CRC)-like signature. For example, the signature may be generated based at least in part on a sequence or configuration associated with the one or more reference signals and, therefore, can be used to perform error checking for the one or more reference signals.

In some aspects, the signature may be associated with one or more reference signals. For example, in some aspects, a single signature may be used in association with verifying a single reference signal. As another example, in some aspects, a single signature may be used in association with verifying multiple reference signals. That is, a single signature may, in some aspects, be associated with a bundle of reference signals. In some aspects, the one or more reference signals may include, for example, a sounding reference signal (SRS), a positioning reference signal (PRS), a channel state information reference signal (CSI-RS), an SSB, a tracking reference signal (TRS), a phase tracking reference signal (PTRS), an RF sensing reference signal, or an ambient IoT tag reference signal (e.g., a reference signal used in association with reading information from an ambient IoT device, such as an RF identification tag), among other examples.

In some aspects, the wireless communication device 305 (e.g., using the signature generator 310) may generate the signature based at least in part on a key and one or more other items of information. For example, with reference to the upper diagram in FIG. 3B, the signature generator 310 may receive a key, an identifier of the wireless communication device 315 (i.e., the wireless communication device that is to receive the one or more reference signals), a configuration associated with the one or more reference signals, time allocation information associated with the one or more reference signals, frequency allocation information associated with the one or more reference signals, a timestamp associated with the one or more reference signals, or a sequence associated with the one or more reference signals as input. As shown, the signature generator 310 may then provide the signature as an output.

In some aspects, an asymmetric encryption scheme may be implemented and, therefore, the key used to generate the signature is a private key (e.g., a secret key known only to the wireless communication device 305). Alternatively, in some aspects, a symmetric encryption scheme may be implemented and, therefore, the key used to generate the signature is a unicast key (e.g., a secret key provided to the wireless communication device 305 for participation in a symmetric encryption scheme) or a groupcast key (e.g., a secret key provided to a group of wireless communication devices 305 for participation in a symmetric encryption scheme). In this case of symmetric key, the key may in some aspects be communicated using layer 3 (L3) signaling (e.g., radio resource control (RRC) signaling) that is L3 secured, layer 2 (L2) signaling (e.g., a medium access control (MAC) control element) if the L2 signaling secured, or layer 1 (L1) control information (e.g., downlink control information or sidelink control information) if the L1 control information is secured.

In some aspects, the wireless communication device 305 may modify the signature to reduce a size of the signature. For example, the wireless communication device 305 may compress the signature or puncture the signature to reduce a size of the signature. For example, the wireless communication device 305 may puncture the signature by removing a last X-d bits from the signature, where d is the desired number of bits and X is the actual size of the signature. In this way, a size of the signature may be reduced, thereby reducing resource consumption associated with transmitting the signature.

As shown by reference 355 in FIG. 3A, the wireless communication device 305 may transmit, and the wireless communication device 315 may receive, the one or more reference signals. Further, as shown by reference 360, the wireless communication device 305 may transmit, and the wireless communication device 315 may receive, the signature associated with the one or more reference signals.

In some aspects, the wireless communication device 305 may multiplex the signature with at least one reference signal of the one or more reference signals. For example, the wireless communication device 305 may multiplex the signature with a payload of a reference signal. Additionally, or alternatively, the wireless communication device 305 may transmit the signature in a set of resources that is separate from another set of resources in which the one or more reference signals are transmitted (e.g., such that there is time or frequency separation between the at least one reference signal and the signature).

As shown by reference 365, the wireless communication device 315 (e.g., using signature verifier 320) may perform a verification of the signature to determine whether the one or more reference signals are legitimate reference signals.

In some aspects, the wireless communication device 315 (e.g., using the signature verifier 320) may perform the verification based at least in part on the key, the signature, and one or more other items of information. For example, with reference to the lower diagram in FIG. 3B, the signature verifier 320 may receive a key, the signature, an identifier of the wireless communication device 315, a configuration associated with the one or more reference signals, time allocation information associated with the one or more reference signals, frequency allocation information associated with the one or more reference signals, a timestamp associated with the one or more reference signals, or a sequence associated with the one or more reference signals as input. As shown, the signature verifier 320 may then provide a verification result as an output. The verification result indicates whether the signature is valid for the one or more reference signals and, therefore, indicates whether the one or more reference signals are legitimate reference signals.

In some aspects, an asymmetric encryption scheme may be implemented and, therefore, the key used to verify the signature is a public key that corresponds to the private key based at least in part on which the signature was generated. Alternatively, in some aspects, a symmetric encryption scheme may be implemented and, therefore, the key used to generate the signature is a unicast key or a groupcast key that matches the key used by the signature generator 310 to generate the signature.

In some aspects, the wireless communication device 315 may modify the signature to restore a size of the signature. For example, the wireless communication device 315 may decompress the signature or un-puncture the signature to restore a size of the signature to a size of the signature as generated by the wireless communication device 305.

In one example of the above-described operations when using an asymmetric encryption scheme, the wireless communication device 305 generates a private key and a public key. The wireless communication device 305 then transmits the public key to the wireless communication device 315 using, for example, layer 1 signaling, layer 2 signaling, or layer 3 signaling (e.g., in an SSB, during initial access, or the like). The wireless communication device 305 then generates a signature associated with a reference signal (e.g., an SSB, an SRS, a CSI-RS, a PRS, or the like) and transmits the signature and the reference signal. The wireless communication device 315 may receive the signature and the reference signal, and may verify the received signature using the public key.

In some aspects, as noted above, the one or more reference signals may include an SSB. In such an aspect, the SSB can be mapped to a particular set of resources, and the signature can be transmitted by the wireless communication device 305, and received by the wireless communication device 315, in the particular set of resources. In some aspects, the SSB is mapped to the particular set of resources based at least in part on, for example, an identifier of the wireless communication device 315, a zone identifier associated with the SSB, or a cell identifier associated with the SSB, among other examples. In this way, each SSB may associated with (i.e., mapped to) a particular set of resources to be used for communicating a signature associated with the SSB.

Notably, SSBs are common signals, and a physical broadcast channel (PBCH) of a given SSB should be decodable. Thus, if the wireless communication device 305 uses a key to secure an SSB, wireless communication devices not connected to the network would be unable to access the network using the SSB. One way to permit SSB security is to allow the wireless communication device 305 to transmit repetitions of an SSB, where a first repetition of the SSB is not secured (and can be used for initial access), and a second repetition of the SSB is secured (and can be used for security authentication during connected modes and when a wireless communication device has previously accessed the network). In some aspects, the non-secure and secure SSBs may be transmitted in a time division multiplexed (TDM) manner, a frequency division multiplexed (FDM) manner, or a spatial division multiplexed (SDM) manner. Thus, in some aspects, the SSB may include a non-secure SSB, such as a legacy SSB, that is to be monitored during initial access, or may include a secure SSB (e.g., a secure SSB that is to be used in a connected mode after initial access).

In some aspects, after establishing initial access, the wireless communication device 305 can transmit a configuration associated with the secure SSB (e.g., via a secure channel, such as radio resource control (RRC) signaling, a physical downlink shared channel (PDSCH), or the like) so that the wireless communication device 315 can monitor the secure SSB and perform verification as described herein. In some aspects, the configuration may include information associated with, for example, a frequency synchronization roster of the secure SSB, a time/frequency configuration of the secure SSB, a time/frequency configuration for a signature associated with the secure SSB, an indication that the signature is to be included in a PBCH payload of the secure SSB, a PSS configuration, an SSS configuration, a DMRS configuration, a CSI-RS configuration, a sequence associated with the secure SSB, a periodicity of the secure SSB, or a time offset of the secure SSB (e.g., relative to the non-secure SSB), among other examples.

In some aspects, in the case of a secure SSB, the wireless communication device 305 may secure one or more channels or signals of the SSB using a key. The one or more channels or signals may include, for example, a physical PBCH of the SSB, a PSS of the SSB, an SSS of the SSB, or a PBCH DMRS of the SSB. In some aspects, the key used to secure the SSB may be derived based at least in part on, for example, a timestamp (e.g., a timestamp indicating when the key is to be generated or updated), a refresh time duration (for obtaining the key), an identifier signaled via layer 3 signaling, a cell identifier, a zone identifier, or an expected angle of arrival associated with the SSB, among other examples. Similarly, in some aspects, the wireless communication device 305 may in some aspects generate a signature associated with the secure SSB, with the signature being generated using a key that is derived based at least in part on, for example, a timestamp (e.g., a timestamp indicating when the key is to be generated or updated), a refresh time duration (for obtaining the key), an identifier signaled via layer 3 signaling, a cell identifier, a zone identifier, or an expected angle of arrival associated with the SSB, among other examples.

In some aspects, the wireless communication device 305 may generate and transmit a single signature associated with the SSB. FIG. 3C is a diagram illustrating an example illustrating transmission of a single signature associated with an SSB. In some aspects, the wireless communication device 305 may transmit multiple signatures associated with the SSB. That is, in some aspects, the wireless communication device 305 may generate and transmit a second signature associated with the SSB. FIG. 3D is a diagram illustrating an example illustrating transmission of multiple signatures associated with an SSB. In some aspects, a given pair of signatures may be transmitted in an FDM manner, as shown in the example of FIG. 3D. Alternatively, a given pair of signatures may in some aspects be transmitted in a TDM manner.

As indicated above, FIGS. 3A-3D are provided as examples. Other examples may differ from what is described with respect to FIGS. 3A-3D.

FIG. 4 is a diagram illustrating an example process 400 performed, for example, by a wireless communication device, in accordance with the present disclosure. Example process 400 is an example where the wireless communication device (e.g., a wireless communication device 305, a UE 120, a base station 110, or the like) performs operations associated with verifying legitimacy of reference signals.

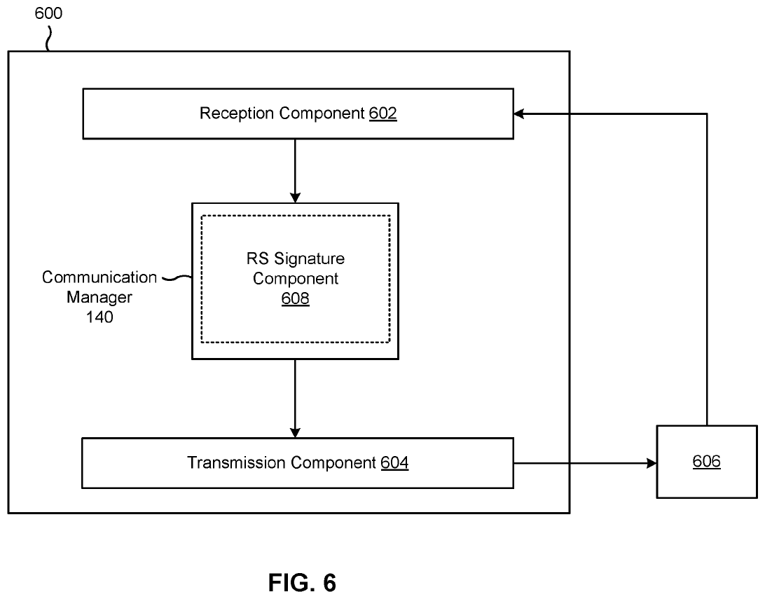

As shown in FIG. 4, in some aspects, process 400 may include generating a signature associated with one or more reference signals to be transmitted by the wireless communication device, wherein the signature is associated with verifying that the one or more reference signals are legitimate reference signals (block 410). For example, the wireless communication device (e.g., using communication manager 140 and/or RS signature component 608, depicted in FIG. 6) may generate a signature associated with one or more reference signals to be transmitted by the wireless communication device, wherein the signature is associated with verifying that the one or more reference signals are legitimate reference signals, as described above.

As further shown in FIG. 4, in some aspects, process 400 may include transmitting the one or more reference signals (block 420). For example, the wireless communication device (e.g., using communication manager 140 and/or transmission component 604, depicted in FIG. 6) may transmit the one or more reference signals, as described above.

As further shown in FIG. 4, in some aspects, process 400 may include transmitting the signature associated with the one or more reference signals (block 430). For example, the wireless communication device (e.g., using communication manager 140 and/or transmission component 604, depicted in FIG. 6) may transmit the signature associated with the one or more reference signals, as described above.

Process 400 may include additional aspects, such as any single aspect or any combination of aspects described below and/or in connection with one or more other processes described elsewhere herein.

In a first aspect, the one or more reference signals include at least one of an SRS, a PRS, a CSI-RS, or an SSB.

In a second aspect, alone or in combination with the first aspect, the signature is generated based at least in part on a key and at least one of an identifier of a receiving wireless communication device that is to receive the one or more reference signals, a configuration associated with the one or more reference signals, time allocation information associated with the one or more reference signals, allocation information associated with the one or more reference signals, or a timestamp associated with the one or more reference signals.

In a third aspect, alone or in combination with one or more of the first and second aspects, the key is a private key associated with an asymmetric encryption scheme.

In a fourth aspect, alone or in combination with one or more of the first through third aspects, the key is a unicast key associated with a symmetric encryption scheme.

In a fifth aspect, alone or in combination with one or more of the first through fourth aspects, process 400 includes modifying the signature to reduce a size of the signature, wherein modifying the signature includes at least one of compressing the signature or puncturing the signature.

In a sixth aspect, alone or in combination with one or more of the first through fifth aspects, the signature is multiplexed with at least one reference signal of the one or more reference signals.

In a seventh aspect, alone or in combination with one or more of the first through sixth aspects, the signature is transmitted in a set of resources that is separate from another set of resources in which the one or more reference signals are transmitted.

In an eighth aspect, alone or in combination with one or more of the first through seventh aspects, the one or more reference signals include an SSB.

In a ninth aspect, alone or in combination with one or more of the first through eighth aspects, process 400 includes mapping the SSB to a particular set of resources, wherein the signature is transmitted in the particular set of resources.

In a tenth aspect, alone or in combination with one or more of the first through ninth aspects, the SSB is mapped to the particular set of resources based at least in part on at least one of an identifier of a receiving wireless communication device to which the SSB is to be transmitted, a zone identifier, or a cell identifier.

In an eleventh aspect, alone or in combination with one or more of the first through tenth aspects, process 400 includes securing a PBCH of the SSB, a PSS of the SSB, an SSS of the SSB, or a PBCH DMRS of the SSB using a key.

In a twelfth aspect, alone or in combination with one or more of the first through eleventh aspects, the key is derived based at least in part on at least one of a timestamp, a refresh time duration, an identifier signaled via layer 3 signaling, a cell identifier, a zone identifier, or an expected angle of arrival associated with the SSB.

In a thirteenth aspect, alone or in combination with one or more of the first through twelfth aspects, the signature is generated using a key that is derived based at least in part on at least one of a timestamp, a refresh time duration, an identifier signaled via layer 3 signaling, a cell identifier, a zone identifier, or an expected angle of arrival associated with the SSB.

In a fourteenth aspect, alone or in combination with one or more of the first through thirteenth aspects, the SSB is a legacy SSB.

In a fifteenth aspect, alone or in combination with one or more of the first through fourteenth aspects, the SSB is a secure SSB to be used in a connected mode.

In a sixteenth aspect, alone or in combination with one or more of the first through fifteenth aspects, the signature is a first signature, and process 400 includes generating a second signature associated with the SSB, and transmitting the second signature associated with the SSB.

In a seventeenth aspect, alone or in combination with one or more of the first through sixteenth aspects, the SSB is a first SSB, and process 400 includes transmitting configuration information associated with a second SSB.

In an eighteenth aspect, alone or in combination with one or more of the first through seventeenth aspects, the configuration information includes information associated with at least one of a frequency synchronization roster of the second SSB, a first time/frequency configuration of the second SSB, a second time/frequency configuration for a second signature associated with the second SSB, an indication that the second signature is to be included in a PBCH payload of the second SSB, a PSS configuration, an SSS configuration, a DMRS configuration, a sequence associated with the second SSB, a periodicity of the second SSB, or a time offset of the second SSB.

In a nineteenth aspect, alone or in combination with one or more of the first through eighteenth aspects, the wireless communication device is a network entity (e.g., a base station 110).

In a twentieth aspect, alone or in combination with one or more of the first through nineteenth aspects, the wireless communication device is a UE (e.g., a UE 120).

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a wireless communication device, in accordance with the present disclosure. Example process 500 is an example where the wireless communication device (e.g., a wireless communication device 315, a UE 120, a base station 110, or the like) performs operations associated with verifying legitimacy of reference signals.

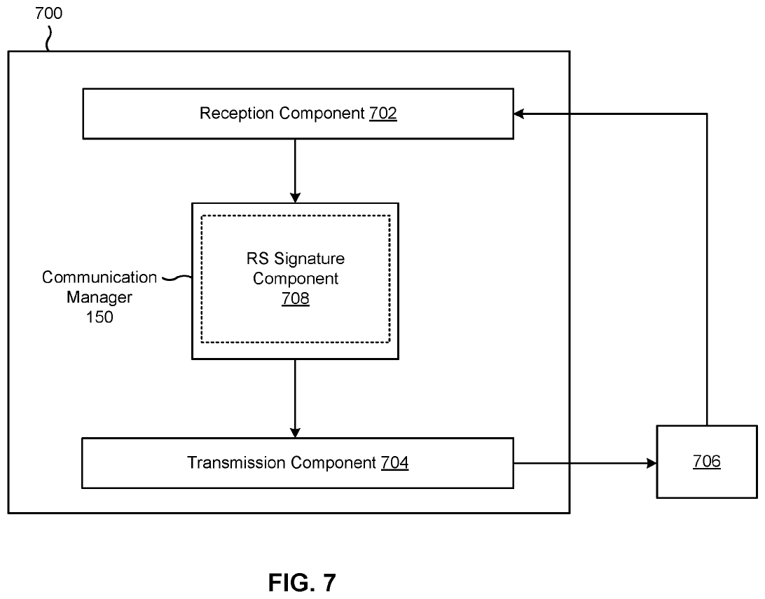

As shown in FIG. 5, in some aspects, process 500 may include receiving one or more reference signals (block 510). For example, the wireless communication device (e.g., using communication manager 150 and/or reception component 702, depicted in FIG. 7) may receive one or more reference signals, as described above.

As further shown in FIG. 5, in some aspects, process 500 may include receiving a signature associated with the one or more reference signals (block 520). For example, the wireless communication device (e.g., using communication manager 150 and/or reception component 702, depicted in FIG. 7) may receive a signature associated with the one or more reference signals, as described above.

As further shown in FIG. 5, in some aspects, process 500 may include performing a verification of the signature to determine whether the one or more reference signals are legitimate reference signals (block 530). For example, the wireless communication device (e.g., using communication manager 150 and/or RS signature component 708, depicted in FIG. 7) may perform a verification of the signature to determine whether the one or more reference signals are legitimate reference signals, as described above.

Process 500 may include additional aspects, such as any single aspect or any combination of aspects described below and/or in connection with one or more other processes described elsewhere herein.

In a first aspect, the one or more reference signals include at least one of an SRS, a PRS, a CSI-RS, or an SSB.

In a second aspect, alone or in combination with the first aspect, the verification of the signature is performed based at least in part on a key and at least one of an identifier of the wireless communication device, a configuration associated with the one or more reference signals, time allocation information associated with the one or more reference signals, allocation information associated with the one or more reference signals, or a timestamp associated with the one or more reference signals.

In a third aspect, alone or in combination with one or more of the first and second aspects, the key is a public key associated with an asymmetric encryption scheme.

In a fourth aspect, alone or in combination with one or more of the first through third aspects, the key is a unicast key associated with a symmetric encryption scheme.

In a fifth aspect, alone or in combination with one or more of the first through fourth aspects, process 500 includes modifying the signature to restore a size of the signature, wherein modifying the signature includes at least one of decompressing the signature or un-puncturing the signature.

In a sixth aspect, alone or in combination with one or more of the first through fifth aspects, the signature is multiplexed with at least one reference signal of the one or more reference signals.

In a seventh aspect, alone or in combination with one or more of the first through sixth aspects, the signature is received in a set of resources that is separate from another set of resources in which the one or more reference signals are received.

In an eighth aspect, alone or in combination with one or more of the first through seventh aspects, the one or more reference signals include an SSB.

In a ninth aspect, alone or in combination with one or more of the first through eighth aspects, process 500 includes mapping the SSB to a particular set of resources, wherein the signature is received in the particular set of resources.

In a tenth aspect, alone or in combination with one or more of the first through ninth aspects, the SSB is mapped to the particular set of resources based at least in part on at least one of an identifier of the wireless communication device, a zone identifier, or a cell identifier.

In an eleventh aspect, alone or in combination with one or more of the first through tenth aspects, a PBCH of the SSB, a PSS of the SSB, an SSS of the SSB, or a PBCH DMRS of the SSB is secured using a key.

In a twelfth aspect, alone or in combination with one or more of the first through eleventh aspects, the key is derived based at least in part on at least one of a timestamp, a refresh time duration, an identifier signaled via layer 3 signaling, a cell identifier, a zone identifier, or an expected angle of arrival associated with the SSB.

In a thirteenth aspect, alone or in combination with one or more of the first through twelfth aspects, process 500 includes a timestamp, a refresh time duration, an identifier signaled via layer 3 signaling, a cell identifier, a zone identifier, or an expected angle of arrival associated with the SSB.

In a fourteenth aspect, alone or in combination with one or more of the first through thirteenth aspects, the SSB is a legacy SSB.

In a fifteenth aspect, alone or in combination with one or more of the first through fourteenth aspects, the SSB is a secure SSB to be used in a connected mode.

In a sixteenth aspect, alone or in combination with one or more of the first through fifteenth aspects, the signature is a first signature, and process 500 includes receiving a second signature associated with the SSB.

In a seventeenth aspect, alone or in combination with one or more of the first through sixteenth aspects, the SSB is a first SSB, and process 500 includes receiving configuration information associated with a second SSB.

In an eighteenth aspect, alone or in combination with one or more of the first through seventeenth aspects, the configuration information includes information associated with at least one of a frequency synchronization roster of the second SSB, a first time/frequency configuration of the second SSB, a second time/frequency configuration for a second signature associated with the second SSB, an indication that the second signature is to be included in a PBCH payload of the second SSB, a PSS configuration, an SSS configuration, a DMRS configuration, a sequence associated with the second SSB, a periodicity of the second SSB, or a time offset of the second SSB.

In a nineteenth aspect, alone or in combination with one or more of the first through eighteenth aspects, the wireless communication device is a network entity (e.g., a base station 110).

In a twentieth aspect, alone or in combination with one or more of the first through nineteenth aspects, the wireless communication device is a UE (e.g., a UE 120).

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a wireless communication device, or a wireless communication device may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include a reference signal (RS) signature component 608, among other examples.

In some aspects, the apparatus 600 may be configured to perform one or more operations described herein in connection with FIGS. 3A-3D. Additionally, or alternatively, the apparatus 600 may be configured to perform one or more processes described herein, such as process 400 of FIG. 4. In some aspects, the apparatus 600 and/or one or more components shown in FIG. 6 may include one or more components of the wireless communication device described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the wireless communication device described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the wireless communication device described in connection with FIG. 2. In some aspects, the transmission component 604 may be co-located with the reception component 602 in a transceiver.

The RS signature component 608 may generate a signature associated with one or more reference signals to be transmitted by the wireless communication device, wherein the signature is associated with verifying that the one or more reference signals are legitimate reference signals. The transmission component 604 may transmit the one or more reference signals. The transmission component 604 may transmit the signature associated with the one or more reference signals.

The RS signature component 608 may modify the signature to reduce a size of the signature, wherein modifying the signature includes at least one of compressing the signature or puncturing the signature.

The transmission component 604 may map the SSB to a particular set of resources, wherein the signature is transmitted in the particular set of resources.

The RS signature component 608 may secure a PBCH of the SSB, a PSS of the SSB, an SSS of the SSB, or a PBCH DMRS of the SSB using a key.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a wireless communication device, or a wireless communication device may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 150. The communication manager 150 may include an RS signature component 708, among other examples.

In some aspects, the apparatus 700 may be configured to perform one or more operations described herein in connection with FIGS. 3A-3D. Additionally, or alternatively, the apparatus 700 may be configured to perform one or more processes described herein, such as process 500 of FIG. 5. In some aspects, the apparatus 700 and/or one or more components shown in FIG. 7 may include one or more components of the wireless communication device described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the wireless communication device described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the wireless communication device described in connection with FIG. 2. In some aspects, the transmission component 704 may be co-located with the reception component 702 in a transceiver.

The reception component 702 may receive one or more reference signals. The reception component 702 may receive a signature associated with the one or more reference signals. The RS signature component 708 may perform a verification of the signature to determine whether the one or more reference signals are legitimate reference signals.

The RS signature component 708 may modify the signature to restore a size of the signature, wherein modifying the signature includes at least one of decompressing the signature or un-puncturing the signature.

The reception component 702 may map the SSB to a particular set of resources, wherein the signature is received in the particular set of resources.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a wireless communication device, comprising: generating a signature associated with one or more reference signals to be transmitted by the wireless communication device, wherein the signature is associated with verifying that the one or more reference signals are legitimate reference signals; transmitting the one or more reference signals; and transmitting the signature associated with the one or more reference signals.

Aspect 2: The method of Aspect 1, wherein the one or more reference signals include at least one of an SRS, a PRS, a CSI-RS, an SSB, a TRS, a PTRS, an RF sensing reference signal, or an ambient IoT tag reference signal.

Aspect 3: The method of any of Aspects 1-2, wherein the signature is generated based at least in part on a key and at least one of an identifier of a receiving wireless communication device that is to receive the one or more reference signals, a configuration associated with the one or more reference signals, time allocation information associated with the one or more reference signals, frequency allocation information associated with the one or more reference signals, or a timestamp associated with the one or more reference signals.

Aspect 4: The method of Aspect 3, wherein the key is a private key associated with an asymmetric encryption scheme.

Aspect 5: The method of Aspect 3, wherein the key is a unicast key associated with a symmetric encryption scheme.

Aspect 6: The method of any of Aspects 1-5, further comprising modifying the signature to reduce a size of the signature, wherein modifying the signature includes at least one of compressing the signature or puncturing the signature.

Aspect 7: The method of any of Aspects 1-6, wherein the signature is multiplexed with at least one reference signal of the one or more reference signals.

Aspect 8: The method of any of Aspects 1-6, wherein the signature is transmitted in a set of resources that is separate from another set of resources in which the one or more reference signals are transmitted.

Aspect 9: The method of any of Aspects 1-8, wherein the one or more reference signals include a synchronization signal block (SSB).

Aspect 10: The method of Aspect 9, further comprising mapping the SSB to a particular set of resources, wherein the signature is transmitted in the particular set of resources.

Aspect 11: The method of Aspect 10, wherein the SSB is mapped to the particular set of resources based at least in part on at least one of an identifier of a receiving wireless communication device to which the SSB is to be transmitted, a zone identifier, or a cell identifier.

Aspect 12: The method of any of Aspects 9-11, further comprising securing a PBCH of the SSB, a PSS of the SSB, an SSS of the SSB, or a PBCH DMRS of the SSB using a key.

Aspect 13: The method of Aspect 12, wherein the key is derived based at least in part on at least one of: a timestamp, a refresh time duration, an identifier signaled via layer 3 signaling, a cell identifier, a zone identifier, or an expected angle of arrival associated with the SSB.

Aspect 14: The method of any of Aspects 9-13, wherein the signature is generated using a key that is derived based at least in part on at least one of: a timestamp, a refresh time duration, an identifier signaled via layer 3 signaling, a cell identifier, a zone identifier, or an expected angle of arrival associated with the SSB.

Aspect 15: The method of any of Aspects 9-14, wherein the SSB is a legacy SSB.

Aspect 16: The method of any of Aspects 9-14, wherein the SSB is a secure SSB to be used in a connected mode.

Aspect 17: The method of any of Aspects 9-16, wherein the signature is a first signature, and the method further comprises generating a second signature associated with the SSB, and transmitting the second signature associated with the SSB.

Aspect 18: The method of any of Aspects 9-17, wherein the SSB is a first SSB, and the method further comprises transmitting configuration information associated with a second SSB.

Aspect 19: The method of Aspect 18, wherein the configuration information includes information associated with at least one of: a frequency synchronization roster of the second SSB, a first time/frequency configuration of the second SSB, a second time/frequency configuration for a second signature associated with the second SSB, an indication that the second signature is to be included in a PBCH payload of the second SSB, a PSS configuration, an SSS configuration, a DMRS configuration, a sequence associated with the second SSB, a periodicity of the second SSB, or a time offset of the second SSB.

Aspect 20: The method of any of Aspects 1-19, wherein the wireless communication device is a network entity.

Aspect 21: The method of any of Aspects 1-19, wherein the wireless communication device is a UE.

Aspect 22: A method of wireless communication performed by a wireless communication device, comprising: receiving one or more reference signals; receiving a signature associated with the one or more reference signals; and performing a verification of the signature to determine whether the one or more reference signals are legitimate reference signals.

Aspect 23: The method of Aspect 22, wherein the one or more reference signals include at least one of an SRS, a PRS, a CSI-RS, an SSB, a TRS, a PTRS, an RF sensing reference signal, or an ambient IoT tag reference signal.

Aspect 24: The method of any of Aspects 22-23, wherein the verification of the signature is performed based at least in part on a key and at least one of an identifier of the wireless communication device, a configuration associated with the one or more reference signals, time allocation information associated with the one or more reference signals, frequency allocation information associated with the one or more reference signals, or a timestamp associated with the one or more reference signals.

Aspect 25: The method of Aspect 24, wherein the key is a public key associated with an asymmetric encryption scheme.

Aspect 26: The method of Aspect 24, wherein the key is a unicast key associated with a symmetric encryption scheme.

Aspect 27: The method of any of Aspects 22-26, further comprising modifying the signature to restore a size of the signature, wherein modifying the signature includes at least one of decompressing the signature or un-puncturing the signature.

Aspect 28: The method of any of Aspects 22-27, wherein the signature is multiplexed with at least one reference signal of the one or more reference signals.

Aspect 29: The method of any of Aspects 22-27, wherein the signature is received in a set of resources that is separate from another set of resources in which the one or more reference signals are received.

Aspect 30: The method of any of Aspects 22-29, wherein the one or more reference signals include an SSB.

Aspect 31: The method of Aspect 30, further comprising mapping the SSB to a particular set of resources, wherein the signature is received in the particular set of resources.

Aspect 32: The method of Aspect 31, wherein the SSB is mapped to the particular set of resources based at least in part on at least one of an identifier of the wireless communication device, a zone identifier, or a cell identifier.

Aspect 33: The method of any of Aspects 30-32, wherein a PBCH of the SSB, a PSS of the SSB, an SSS of the SSB, or a PBCH DMRS of the SSB is secured using a key.

Aspect 34: The method of Aspect 33, wherein the key is derived based at least in part on at least one of: a timestamp, a refresh time duration, an identifier signaled via layer 3 signaling, a cell identifier, a zone identifier, or an expected angle of arrival associated with the SSB.

Aspect 35: The method of any of Aspects 30-34, wherein the signature is based at least in part on a key that is derived based at least in part on at least one of a timestamp, a refresh time duration, an identifier signaled via layer 3 signaling, a cell identifier, a zone identifier, or an expected angle of arrival associated with the SSB.

Aspect 36: The method of any of Aspects 30-35, wherein the SSB is a legacy SSB.

Aspect 37: The method of any of Aspects 30-35, wherein the SSB is a secure SSB to be used in a connected mode.

Aspect 38: The method of any of Aspects 30-37, wherein the signature is a first signature, and the method further comprises receiving a second signature associated with the SSB.

Aspect 39: The method of any of Aspects 30-38, wherein the SSB is a first SSB, and the method further comprises receiving configuration information associated with a second SSB.

Aspect 40: The method of Aspect 39, wherein the configuration information includes information associated with at least one of: a frequency synchronization roster of the second SSB, a first time/frequency configuration of the second SSB, a second time/frequency configuration for a second signature associated with the second SSB, an indication that the second signature is to be included in a PBCH payload of the second SSB, a PSS configuration, an SSS configuration, a DMRS configuration, a sequence associated with the second SSB, a periodicity of the second SSB, or a time offset of the second SSB.

Aspect 41: The method of any of Aspects 22-40, wherein the wireless communication device is a network entity.

Aspect 42: The method of any of Aspects 22-40, wherein the wireless communication device is a UE.

Aspect 43: An apparatus for wireless communication at a device, comprising a processor; memory coupled with the processor; and instructions stored in the memory and executable by the processor to cause the apparatus to perform the method of one or more of Aspects 1-21.

Aspect 44: A device for wireless communication, comprising a memory and one or more processors coupled to the memory, the one or more processors configured to perform the method of one or more of Aspects 1-21.

Aspect 45: An apparatus for wireless communication, comprising at least one means for performing the method of one or more of Aspects 1-21.

Aspect 46: A non-transitory computer-readable medium storing code for wireless communication, the code comprising instructions executable by a processor to perform the method of one or more of Aspects 1-21.

Aspect 47: A non-transitory computer-readable medium storing a set of instructions for wireless communication, the set of instructions comprising one or more instructions that, when executed by one or more processors of a device, cause the device to perform the method of one or more of Aspects 1-21.

Aspect 48: An apparatus for wireless communication at a device, comprising a processor; memory coupled with the processor; and instructions stored in the memory and executable by the processor to cause the apparatus to perform the method of one or more of Aspects 22-42.

Aspect 49: A device for wireless communication, comprising a memory and one or more processors coupled to the memory, the one or more processors configured to perform the method of one or more of Aspects 22-42.

Aspect 50: An apparatus for wireless communication, comprising at least one means for performing the method of one or more of Aspects 22-42.

Aspect 51: A non-transitory computer-readable medium storing code for wireless communication, the code comprising instructions executable by a processor to perform the method of one or more of Aspects 22-42.

Aspect 52: A non-transitory computer-readable medium storing a set of instructions for wireless communication, the set of instructions comprising one or more instructions that, when executed by one or more processors of a device, cause the device to perform the method of one or more of Aspects 22-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device for wireless communication, comprising:
a memory; and
one or more processors, coupled to the memory, configured to:
generate a signature associated with one or more reference signals to be transmitted by the wireless communication device,
wherein the signature is associated with verifying that the one or more reference signals are legitimate reference signals;
transmit the one or more reference signals; and
transmit the signature associated with the one or more reference signals.

2. The wireless communication device of claim 1, wherein the one or more reference signals include at least one of a sounding reference signal (SRS), a positioning reference signal (PRS), a channel state information reference signal (CSI-RS), a synchronization signal block (SSB), a tracking reference signal (TRS), a phase tracking reference signal (PTRS), a radio frequency (RF) sensing reference signal, or an ambient Internet-of-Things (IoT) tag reference signal.

3. The wireless communication device of claim 1, wherein the signature is generated based at least in part on a key and at least one of:
an identifier of a receiving wireless communication device that is to receive the one or more reference signals,
a configuration associated with the one or more reference signals,
time allocation information associated with the one or more reference signals,
frequency allocation information associated with the one or more reference signals, or
a timestamp associated with the one or more reference signals.

4. The wireless communication device of claim 3, wherein the key is a private key associated with an asymmetric encryption scheme.

5. The wireless communication device of claim 3, wherein the key is a unicast key associated with a symmetric encryption scheme.

6. The wireless communication device of claim 1, wherein the one or more processors are further to modify the signature to reduce a size of the signature, wherein modifying the signature includes at least one of compressing the signature or puncturing the signature.

7. The wireless communication device of claim 1, wherein the signature is multiplexed with at least one reference signal of the one or more reference signals.

8. The wireless communication device of claim 1, wherein the signature is transmitted in a set of resources that is separate from another set of resources in which the one or more reference signals are transmitted.

9. The wireless communication device of claim 1, wherein the one or more reference signals include a synchronization signal block (SSB).

10. The wireless communication device of claim 9, wherein the one or more processors are further to map the SSB to a particular set of resources, wherein the signature is transmitted in the particular set of resources.

11. The wireless communication device of claim 10, wherein the SSB is mapped to the particular set of resources based at least in part on at least one of an identifier of a receiving wireless communication device to which the SSB is to be transmitted, a zone identifier, or a cell identifier.

12. The wireless communication device of claim 9, wherein the one or more processors are further to secure a physical broadcast channel (PBCH) of the SSB, a primary synchronization signal (PSS) of the SSB, a secondary synchronization signal (SSS) of the SSB, or a PBCH demodulation reference signal (DMRS) of the SSB using a key.

13. The wireless communication device of claim 12, wherein the key is derived based at least in part on at least one of:
a timestamp,
a refresh time duration,
an identifier signaled via layer 3 signaling,
a cell identifier,
a zone identifier, or
an expected angle of arrival associated with the SSB.

14. The wireless communication device of claim 9, wherein the signature is generated using a key that is derived based at least in part on at least one of:
a timestamp,
a refresh time duration,
an identifier signaled via layer 3 signaling,
a cell identifier,
a zone identifier, or
an expected angle of arrival associated with the SSB.

15. The wireless communication device of claim 9, wherein the SSB is a legacy SSB.

16. The wireless communication device of claim 9, wherein the SSB is a secure SSB to be used in a connected mode.

17. The wireless communication device of claim 9, wherein the signature is a first signature, and the one or more processors are further to:
generate a second signature associated with the SSB, and
transmit the second signature associated with the SSB.

18. The wireless communication device of claim 9, wherein the SSB is a first SSB, and the one or more processors are further to transmit configuration information associated with a second SSB.

19. The wireless communication device of claim 18, wherein the configuration information includes information associated with at least one of:
a frequency synchronization roster of the second SSB,
a first time/frequency configuration of the second SSB,
a second time/frequency configuration for a second signature associated with the second SSB,
an indication that the second signature is to be included in a physical broadcast channel (PBCH) payload of the second SSB,
a primary synchronization signal (PSS) configuration,
a secondary synchronization signal (SSS) configuration,
a demodulation reference signal (DMRS) configuration,
a sequence associated with the second SSB,
a periodicity of the second SSB, or
a time offset of the second SSB.

20. The wireless communication device of claim 1, wherein the wireless communication device is a network entity.

21. The wireless communication device of claim 1, wherein the wireless communication device is a user equipment (UE).

22. A wireless communication device for wireless communication, comprising:
a memory; and
one or more processors, coupled to the memory, configured to:
receive one or more reference signals;
receive a signature associated with the one or more reference signals; and
perform a verification of the signature to determine whether the one or more reference signals are legitimate reference signals.

23. The wireless communication device of claim 22, wherein the one or more reference signals include at least one of a sounding reference signal (SRS), a positioning reference signal (PRS), a channel state information reference signal (CSI-RS), a synchronization signal block (SSB), a tracking reference signal (TRS), a phase tracking reference signal (PTRS), a radio frequency (RF) sensing reference signal, or an ambient Internet-of-Things (IoT) tag reference signal.

24. The wireless communication device of claim 22, wherein the verification of the signature is performed based at least in part on a key and at least one of:
an identifier of the wireless communication device,
a configuration associated with the one or more reference signals,
time allocation information associated with the one or more reference signals,
frequency allocation information associated with the one or more reference signals, or
a timestamp associated with the one or more reference signals.

25. The wireless communication device of claim 22, wherein the one or more processors are further to modify the signature to restore a size of the signature, wherein modifying the signature includes at least one of decompressing the signature or un-puncturing the signature.

26. The wireless communication device of claim 22, wherein the signature is multiplexed with at least one reference signal of the one or more reference signals.

27. The wireless communication device of claim 22, wherein the signature is received in a set of resources that is separate from another set of resources in which the one or more reference signals are received.

28. The wireless communication device of claim 22, wherein the one or more reference signals include a synchronization signal block (SSB).

29. A method of wireless communication performed by a wireless communication device, comprising:
generating a signature associated with one or more reference signals to be transmitted by the wireless communication device,
wherein the signature is associated with verifying that the one or more reference signals are legitimate reference signals;
transmitting the one or more reference signals; and
transmitting the signature associated with the one or more reference signals.

30. A method of wireless communication performed by a wireless communication device, comprising:
receiving one or more reference signals;
receiving a signature associated with the one or more reference signals; and
performing a verification of the signature to determine whether the one or more reference signals are legitimate reference signals.
